(19) United States
(12) Patent Application Publication
(10) Pub. No.: US 2026/0104683 A1
(43) Pub. Date: Apr. 16, 2026

(54) METHOD FOR CONTROLLING A MECHATRONIC SYSTEM

(71) Applicants: CENTRE NATIONAL DE LA RECHERCHE SCIENTIFIQUE, PARIS (FR); CENTRALESUPELEC, GIF-SUR-YVETTE (FR); SAFRAN ELECTRONICS & DEFENSE, PARIS (FR)

(72) Inventors: Maxime POUILLY-CATHELAIN, MOISSY CRAMAYEL (FR); Philippe FEYEL, MOISSY CRAMAYEL (FR); Yannick Ghislain Sébastien Xavier ATTRAZIC, MOISSY CRAMAYEL (FR); Gilles DUC, GIF-SUR-YVETTE (FR); Guillaume SANDOU, GIF-SUR-YVETTE (FR)

(21) Appl. No.: 19/115,593

(22) PCT Filed: Sep. 20, 2023
(86) PCT No.: PCT/FR2023/051439

§ 371 Date: Mar. 26, 2025

(30) Foreign Application Priority Data
Sep. 27, 2022 (FR) FR2209757

(51) Int. Cl. G05B 13/04

(52) U.S. Cl. CPC G05B 13/048

(57) ABSTRACT

A method for controlling a mechatronic system, based on a model for predicting the behaviour of the mechatronic system and a cost function ensuring compliance with constraints by the mechatronic system, with a view to following path instructions to a prediction horizon, the method including reformulating the constraints into barrier functions and integrating the barrier functions into the cost function; and for each sampling period of a sequence of sampling periods: obtaining the path instructions and at least one measurement of the mechatronic system in a current state; determining coefficients of a polynomial of order m using a Nelder-Mead method optimizing the cost function based on the predicting model, this determining receiving as input the path instructions and the at least one measurement of the mechatronic system obtained; computing a command through evaluation of the polynomial; and applying the command to the mechatronic system.

### TECHNICAL FIELD OF THE INVENTION

The technical field of the invention is that of automation and in particular mechatronic systems.

The present invention relates to a method for controlling a mechatronic system and in particular a method for controlling a mechatronic system based on a prediction model of the behaviour of the mechatronic system.

### TECHNOLOGICAL BACKGROUND OF THE INVENTION

The field of mechatronics combines mechanics, electronics, automation and computing science in real time. The interest of this interdisciplinary engineering field lies in the design of automatic systems and the automatic control of complex systems.

A mechatronic system comprises at least two subsystems: an operative part and a control part. For example, a mechatronic system comprises an electric motor carrying a mechanical load, which corresponds to the operative part of the system, whose position and/or velocity is measured with a position and/or velocity sensor. In this example, the operative part will be the electric motor, the mechanical load as well as the sensors. In order to actuate the motor, a control voltage, expressed in volts for example, is applied to the motor. Actuating the motor causes a change in the position of the mechanical load. The control section may comprise a corrector, for example, which, from a measurement, will determine the command(s) sent to the operative part. The so-called adaptive corrector will also adapt parameters of the corrector so that its operation depends on the environmental conditions in order to follow an instruction. In addition, this corrector will reject the outer disturbances determined from one or more measurements in order to enable the mechatronic system to follow an instruction by generating one or more commands sent to the operative part. For the sake of simplicity, the term “mechatronic system” may be used to designate the operative part of the mechatronic system when the command is applied to the operative part.

An example of a mechatronic system is the gyro-stabilised sight. A gyro-stabilised sight is an optronic system that allows observation at very great distances in a precise direction. The gyro-stabilised sight can be mounted to a vehicle, for example. In this case, the aim of the sight is to keep orientation of a mechanical load (for example, an optronic device such as a camera) carried by motors, being fixed despite movements of the vehicle. Several sight architectures are possible [Masten M., 2008, Inertially stabilized platforms for optical imaging systems: Tracking dynamic targets with mobile sensors. Control Systems, IEEE. 28.47-64.10.1109/MCS.2007.910201], which is incorporated by reference in the application. One of the most common sight architectures consists in employing inertial sensors, such as gyrometers, carried by the mechanical load in order to servo-control the absolute velocity of the mechanical load. In this way, the load becomes inertial except for imperfections and disturbances linked to environmental conditions.

Sights, and in particular single-stabilisation stage sights, are a typical application of adaptive control especially because of:
variety of the environment in which they are employed, all of which are sources of disturbance that can destabilise this inertia targeted,
wear on the system,
dispersion on the mounting lines,
cost of developing servo-controls for these sights, which is considerable in case of change of the mechanical definition and high-level specification.

An active mini-handle, a flap actuation system, a horizontal plane actuation system, a spoiler rotary actuator, a reverse actuator such as the eTRAS (Electrical Thrust Reverser Actuation System) model manufactured by the Safran group, a camera autofocus and an inertial sight are other examples of mechatronic systems.

In order to control the mechatronic system, a trajectory instruction is provided to the system. A trajectory instruction is a sequence of states that the mechatronic system has to follow. A trajectory instruction can be defined, for example, by a target position and/or velocity that the mechanical load of the mechatronic system has to follow. In the case of the gyro-stabilised sight, a trajectory instruction is the precession velocity profile that the sight has to follow.

The mechatronic system needs to install a servo-control loop in order to follow this trajectory instruction. The general principle of a servo-control loop is to compare the trajectory instruction and the system state in order to correct it effectively. Thus, from the difference between the trajectory instruction and the current state of the system, a corrector calculates the next command to be applied to the motor so that the mechatronic system follows the trajectory instruction. For a gyro-stabilised sight, an example of a command is the voltage, in volts, applied across the motor.

The way in which the mechatronic system has to follow this instruction can be restricted. This restriction is for example defined by high level requirements and/or more generally by product specifications. A high-level requirement is a restriction, formulated by the user, on the behaviour of the mechatronic system during the phase of use. A high-level requirement may directly derive from the product specifications. A high-level requirement may correspond to the required stability of the mechatronic system or even to the power consumption of the mechatronic system when following the trajectory instruction. In the case of a gyro-stabilised sight, examples of high-level requirements may consist in:
bounding the standard deviation of the position error obtained by integrating the absolute velocity following error,
bounding the peak value of the position error obtained by integrating the absolute velocity following error,
bounding the standard deviation of the motor voltage, and
bounding the peak value of the motor voltage.

A high-level requirement may have different objectives. For example, for the gyro-stabilised sight, the high-level requirement “bounding the standard deviation of the position error obtained by integrating the velocity following error” makes it possible to ensure that the sight is sufficiently accurate for the target seen by the optical or optronic device to be sharp, while “bounding the peak value of the motor voltage” makes it possible to ensure integrity of the motor.

The current state of the system can be evaluated from at least one measurement. For example, the current state of a mechatronic system can be evaluated from measurements comprising a measurement of its absolute position and/or velocity. As regards a gyro-stabilised sight, a measurement used may be, among other measurements such as the motor current, the absolute velocity of the sight, measured by a gyrometer.

In order to evaluate the current state of a system, it is known to use an observer. The role of an observer is, for example, to enable the current state of a system to be reconstructed or estimated in real time from available measurements. As a result, it is possible that the measurements obtained are not directly processed by the control part of the mechatronic system and an observer may have to be added to estimate the system state. It should be noted that an observer can also be used to estimate the unmeasured states of a system, and also to replace sensors that are expensive or difficult to maintain. With the help of an observer, the current state of the system can be estimated from position and/or velocity measurements alone.

In order to servo-control a mechatronic system, and in particular a gyro-stabilised sight, complying with the high level requirements, the sampling rate of the servo-control loops and the bandwidth of the mechatronic system should be sufficiently high. For example, the minimum sampling frequency required may be at least 50 hertz (Hz), 500 hertz (Hz) or any frequency between 50 and 500 hertz (Hz). The calculation time of the corrector is often critical in order to obtain a sufficiently high sampling frequency. It is also known in the field of mechatronic systems that the sampling frequency of the servo-control loops should be at least 10 times greater than the bandwidth of the mechatronic system and preferably at least 20 times greater than the bandwidth of the mechatronic system.

To achieve a sufficiently high sampling frequency, the servo-control of a mechatronic system is usually made using a static digital corrector. A static digital corrector is a corrector whose parameters are defined before it is used and do not change during use. Thus, it is common for the parameters of these correctors to be defined during the design phase and then not to be modified during the phase of use.

Techniques have already been carried out to optimise corrector parameters, especially based on modelling of the mechatronic system. These parameterisation techniques are used during the development and fine-tuning phases of the mechatronic system, but are not integrated into the servo-control loops and used during the phase of use. The correctors developed in this way are defined to cover a range of ignorance with the system to be servo-controlled and its change over time, for requirements fixed before the phase of use, or even before the development phase of the mechanical system.

In addition, a mechatronic system has to guarantee sufficient stability. To put it simply, a system is stable if, in response to a bounded input, the output of the system is bounded. In order to guarantee stability of the servo-controlled system, the correctors are designed to give the resulting servo-control loop large stability margins, thus limiting performance of the mechatronic system.

In order to have a functional servo-control throughout the life of the system, it is necessary to develop a servo-control that is robust to its potential changes, which are assumed to be bounded. This robustness is achieved at the expense of system performance. Commonly used correctors are thus developed specifically for a product and are sub-optimal in order to increase robustness of the servo-control system. In other words, by implementing sub-optimal correctors it is possible to obtain robust correctors that can be usable despite the appearance of different scenarios during their use, such as dispersion of the system components, variations in the external environment, ageing of the system to be servo-controlled, etc. This is the principle of increasing the robustness of the corrector by reducing performance of the system.

To take better account of variations in the environment, such as variations in temperature, pressure, vibration, etc., it is possible to use additional sensors and/or observers. These additional sensors or observers will provide additional data in order to feed robust adaptive techniques. Thus, these methods enable robust correctors that adapt to variations in the environment to be achieved. However, with current correctors, when a system to be servo-controlled changes the platform on which it is based or when the high-level requirements are modified, the corrector has to be adjusted again in order to adapt it to the new environment and/or the new high-level requirements. Thus, the transition from using a gyro-stabilised sight on an aeroplane to using it on a helicopter is not immediate because the vibration spectra are different, i.e. from the point of view of the mechatronic system comprising the sight, its disturbances, herein vibrations, are different and the mechatronic system requires a new initialisation phase. An initialisation phase is a phase during which the parameters of the corrector are initialised so that its behaviour is adapted during the next phase of use.

A well-known example of a robust adaptive technique is the Linear Parameter Varying (LPV) formalism. A first drawback relating to the LPV formalism is the difficulty of proving stability of this technique in the presence of observers. In addition, the LPV formalism does not adapt to variations in high-level requirements: when these change, a process of designing and adjusting the corrector should thus be restarted, as well as a whole validation and qualification phase, which is very time-consuming and costly. In other words, the LPV formalism does not make it possible to obtain a so-called self-adapting corrector, with the ability to adapt both to variations in the environment and to variations in constraints linked to high-level requirements and/or specifications during the phase of use of the mechatronic system. With regard to gyro-stabilised sights, it is not possible with current control methods to perform self-adaptive control.

Furthermore, manufactured and/or assembled mechatronic systems may exhibit performance non-compliances, especially due to part tolerancing problems. This can lead costly rework or even scrap. The usual correctors are not, or only to a very limited extent, able to compensate for manufacturing faults bringing about non-compliance with performance requirements.

A known control method for servo-controlling a mechatronic system is predictive control described in document [Rawlings, J. B., Mayne, D. Q., & Diehl, M. (2017). Model Predictive Control: Theory, Computation, and Design. Nob Hill Publishing. Reble, M. and Allg], which is incorporated by reference in this application. Predictive control is a process which, for each sampling period, determines a sequence of future commands to achieve optimal predicted future behaviour, with respect to a specification, of the mechatronic system. In this way, predictive control aims to solve a potentially non-linear restricted optimisation problem on-line, for defining the best command to be applied to perform the system control. The behaviour is predicted by virtue of a prediction model of the mechatronic system. The behaviour considered optimal is evaluated by virtue of minimising a cost function using an optimisation algorithm. The cost function is used to determine what is considered optimal for the behaviour of the system: following the trajectory instruction by following a reference trajectory while satisfying the constraints reflecting the high-level requirements as best as possible. By virtue of minimising the cost function, the optimisation algorithm used in predictive control can therefore determine the optimal future sequence of commands in terms of meeting the constraints.

A prediction horizon is a period of time in the future for which the trajectory instruction to be followed is known. It can, for example, be a multiple of the sampling period. In practice, the prediction horizon is generally at least 20 times longer than the sampling period. For a prediction horizon of n sampling periods, the sequence of commands to be determined consists of n commands, one per sampling period. FIG. 6 is a graph showing an example of values of commands (C) as a function of time (T). The present time is represented by the hatched line 600 and the prediction horizon is the time between the hatched line 600 and the hatched line 690. Commands 610 have already been applied to the system. Commands 620, 630, 640, 650, 660 and 670 are commands predicted at the present time so that the mechatronic system follows the trajectory instruction for the prediction horizon. Thus, in FIG. 6, the prediction horizon consists of 6 sampling periods.

For each sampling period, the sliding horizon principle is applied: only the first command in the determined sequence of commands is applied to the mechatronic system. This sliding horizon principle ensures that the command is finally optimal at the current instant.

It should be noted that predictive control as set forth in Rawlings et al., 2017, cannot address the problem of variations in constraints related to high-level requirements and/or specifications during the phase of use of the mechatronic system. Indeed, predictive control as set forth in Rawlings et al., 2017 does not take account of any type of complex and potentially non-derivable high-level requirements and/or specifications. Thus, in order to add new functionality incorporating a sight within a more complex and intelligent system, it is not possible to recalibrate the sight during its phase of use in the case of a specification change.

Other techniques derived from artificial intelligence such as reinforcement learning techniques, exist for controlling a mechatronic system. However, taking high-level requirements into account is very complex and stability is by no means guaranteed by these techniques.

There is therefore a need to provide a method for controlling mechatronic systems that addresses the problems discussed previously.

### SUMMARY OF THE INVENTION

The invention offers a solution to the problems discussed previously, enabling a mechatronic system to be servo-controlled stably and at a high sampling rate.

One aspect of the invention relates to a method for controlling a mechatronic system, based on a prediction model of the behaviour of the mechatronic system and a cost function ensuring compliance with constraints by the mechatronic system for following a trajectory instruction during a prediction horizon, the method comprising:
reformulating the constraints into barrier functions and integrating the barrier functions into the cost function; and
for each sampling period in a sequence of sampling periods:
   obtaining the trajectory instruction and at least one measurement of the mechatronic system in a current state;
   determining coefficients of a polynomial of order m by a Nelder-Mead method optimising the cost function on the basis of the prediction model, the determination taking as an input the trajectory instruction and the at least one measurement of the mechatronic system obtained;
   calculating a command by evaluating the polynomial; and
   applying the command to the mechatronic system.

By virtue of the invention, the time of calculating the command depends on the order m of the polynomial, which can be determined by a user as a function of the sampling frequency required for the servo-control to function correctly. The use of the Nelder-Mead method [Nelder and Mead, 1965:“a simplex method for function minimization”, Computer Journal, vol. 7, no 4, p 308-313] to determine the coefficients of the polynomial makes it possible to obtain a sufficiently high sampling frequency, due to the reduction in calculation time that the Nelder-Mead method allows, for the servo-control of a mechatronic system for an order m less than or equal to 3 with an Intel® Core™ i7 processor. Thus, the implementation of this control method is made easier in an embedded system. In addition, the use of the Nelder-Mead method makes it possible to obtain a stable control method. Finally, the cost function incorporating barrier functions as described in this application enables the mechatronic system to comply with constraints when following a trajectory instruction. In other words, employing a Nelder-Mead method, possibly under constraints, is an essential characteristic of the invention, especially in order to obtain a sufficiently high sampling frequency.

Further to the characteristics just discussed in the preceding paragraph, the control method according to one aspect of the invention may have one or more additional characteristics from among the following, considered individually or according to any technically possible combination:
the control method further comprises a prior step of initialising the prediction model comprising determining the values of a set of parameters of the prediction model using an identification algorithm taking as an input a sequence of step commands of random amplitude and duration and a set of measurements of the mechatronic system, each measurement of the set of measurements of the mechatronic system being made after applying each command of the sequence of commands to the mechatronic system,
the Nelder-Mead method for optimising the cost function is based on a polytope with m+1 vertices, with m the order of the polynomial, whose m+1 vertices are restricted within a predetermined range of values [xmin, xmax] for any change of the polytope during optimisation,
the order m of the polynomial is between 2 and 20, preferably 3,
   When the order m of the polynomial is between 2 and 20, coupling the Nelder-Mead method with the polynomial for interpolating the sequence of commands improves performance of the method according to the invention, in particular by reducing calculation times.
obtaining the trajectory instruction and at least one measurement of the mechatronic system in a current state further comprises estimating in real-time a current state of the mechatronic system from the at least one measurement of the mechatronic system obtained, estimating being performed by an observer included in the mechatronic system,
the control method further comprises, for at least one sampling period of the sequence of sampling periods different from a first sampling period of the sequence of sampling periods, the steps of:
   before determining the coefficients of the polynomial, replacing the barrier functions with new barrier functions, the new barrier functions being a reformulation of the new constraints;
   after obtaining the trajectory instruction and the at least one measurement of the mechatronic system and before determining the coefficients of the polynomial, a step comprising:
      saving the at least one measurement of the mechatronic system obtained in a first variable;
      determining a value for the parameters in the prediction model based on an identification algorithm taking as an input:
         at least one part of the at least one measurement of the mechatronic system obtained during preceding sampling periods stored in the first variable; and
         at least one part of the first commands applied to the mechatronic system during preceding sampling periods stored in a second variable; and
      replacing a current value of the parameters in the prediction model with the value determined; and
   after calculating the command:
      saving the command calculated in a second variable.

Another aspect of the invention relates to a mechatronic system comprising:
a processor implementing the method of the invention; and
a system adapted to obtain at least one measurement of the mechatronic system.

Another aspect of the invention relates to a gyro-stabilised sight comprising:
a processor implementing the method according to the invention; and
a system adapted to obtain at least one measurement of the gyro-stabilised sight.

Further to the characteristics just discussed in the two last paragraphs, the mechatronic system and/or the gyro-stabilised sight may also comprise a memory for saving data, this memory being coupled to the processor. This memory is adapted, for example, to store the first and second variables of the steps for saving the at least one measurement of the mechatronic system obtained in a first variable and the command calculated in a second variable.

Another aspect of the invention relates to a computer program product comprising instructions which, when the program is executed by a computer, cause the same to carry out the method according to the invention.

Another aspect of the invention relates to a computer-readable recording medium comprising instructions which, when executed by a computer, cause the same to carry out the method according to the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.
FIG. 1 shows a schematic representation of the method for controlling a mechatronic system according to the invention.
FIGS. 2 to 5 show a schematic representation of alternatives of the invention.
FIG. 6 is a graph showing an example of values of commands (C) as a function of time (T).
FIG. 7 is a graph showing an example of values of commands (C), calculated by evaluating a polynomial, as a function of time (T).

### DETAILED DESCRIPTION

Unless otherwise specified, a same element appearing in different figures has a single reference.

FIG. 1 shows a schematic representation of the method 100 for controlling a mechatronic system according to the invention.

The control method 100 can be carried out by computer or by a processor. By “carried out by computer”, it is meant that the steps, or virtually all the steps, are executed by at least one computer or processor or other similar system. Thus, steps are made by the calculator, possibly fully automatically or semi-automatically. In examples, at least some of the steps in the method may be triggered by user-computer interaction. The level of user-computer interaction required may depend on the level of automation envisaged and balanced against the need to implement the user's desires. In examples, this level may be user-defined and/or predefined.

A typical example of a computer implementation of a method is to execute the method with a system adapted for the purpose. The system may comprise a processor coupled to a memory and a graphical user interface (GUI), the memory having recorded thereon a computer program comprising instructions for carrying out the method. The memory may also store a database. The memory is any hardware adapted for such storage, possibly comprising a number of distinct physical parts.

The control method 100 is based on a prediction model of the behaviour of the mechatronic system. The prediction model is a mathematical model of the mechatronic system to be controlled. Several prediction models exist, such as those based on neural networks or linear models. The invention can be used with these existing prediction models. The prediction model of the behaviour of the mechatronic system allows simulation of the actual behaviour of the mechatronic system. Thus, the prediction model allows, from one or more input values, to obtain a prediction of an output corresponding to the state in which the mechatronic system would be if the input values were actually applied thereto. For example, in the case of a gyro-stabilised sight, the input and output types of the prediction model are identical to those of the sight:
The input is the voltage applied across the motor,
The output used is the absolute velocity of the sight measured by a gyrometer.

With regard to the output used for a gyro-stabilised sight, it is also possible to measure the absolute angular position of the gyro-stabilised sight.

The control method 100 is also based on a cost function ensuring compliance with constraints by the mechatronic system for following a trajectory instruction during a prediction horizon. The cost function used in the present invention ensures compliance with constraints by the mechatronic system for following a trajectory instruction because it incorporates barrier functions as described in [Wills, A. G. and Heath, W. P. (2004). Barrier function based model predictive control. Automatica, 40(8), 1415-1422], which is incorporated by reference in the application.

The term “constraints” here refers to high-level requirements that derive from the system specifications and/or directly from the system specifications.

Following the trajectory instruction herein corresponds to reducing the difference between the n predicted states of the mechatronic system and the sequence of n next trajectory instructions. The difference between these two elements is then minimised over the entire prediction horizon.

The cost function reflects the constraints that the mechatronic system should meet. The cost function also reflects a following optimisation. As such, the cost function can be used to determine what is considered to be optimal for the system behaviour: following the trajectory instruction as closely as possible to a reference trajectory while guaranteeing compliance with the constraints.

The method 100 comprises reformulating 10 the constraints into barrier functions and integrating the barrier functions into the cost function. In this way, the constraints provided by the user are reformulated into barrier functions so that they can be taken into account in the cost function. In one example, each restriction is reformulated as a barrier function. Wills and Heath, 2004 set forth a control method that includes weighted barrier functions in the cost function. The barrier functions, as set forth in Wills and Heath, 2004, guarantee that the constraints are strictly satisfied. The reformulation method set forth in Wills and Heath, 2004 is compatible with the invention.

Steps 20, 30, 40 and 50 of the method 100 are performed for each sampling period of a sequence of sampling periods. The sequence of sampling periods corresponds to the phase of use of the mechatronic system or at least one part of this phase of use. Each sampling period has therefore to be reduced, for example to less than 0.01 second or 0.001 second or even 0.0002 second.

The method 100 comprises obtaining 20 the trajectory instruction and at least one measurement of the mechatronic system for the current sampling period. The trajectory instruction may be provided by the user or determined semi-automatically or even automatically. It may be constant or different for several consecutive sampling periods or even for the entire sequence of sampling periods. In the case of a gyro-stabilised sight, the trajectory instruction is the precession velocity imposed on the sight, i.e. the velocity profile that the sight has to follow.

The at least one measurement of the mechatronic system can be obtained using one or more sensors. For example, the measurement used for a gyro-stabilised sight is the absolute velocity of the sight measured by a gyrometer. The at least one measurement of the mechatronic system employed by the corrector can also be calculated, i.e. reconstructed or estimated, using an observer.

The method 100 comprises determining 30 the coefficients of a polynomial of order m by a Nelder-Mead method optimising the cost function based on the prediction model, the determination taking as an input the trajectory instruction and the at least one measurement of the mechatronic system for the current sampling period.

During this step 30, the m coefficients of the polynomial are determined. The determination is performed by optimising the cost function described previously. The optimisation is carried out by the Nelder-Mead method, described in the document Nelder and Mead (1965), which is incorporated by reference in the application. The Nelder-Mead method is used to optimise complex cost functions. The principle of the Nelder-Mead method is as follows: in order to minimise a function f(x), with x restricted in the interval [xₘᵢₙ, xₘₐₓ], a simplex is a polytope with s+1 vertices in a s-dimensional space. s is therefore the dimension of the optimisation problem, i.e. the size of the vector x. Starting with such a simplex, it undergoes simple transformations during iterations as a function of what it discovers about the function f(x). The simplex is deformed, for example by undergoing expansions and/or contractions and/or reflections, it moves and shrinks progressively until its vertices approach a point where the function f(x) is locally minimal.

In other words, at each iteration, the optimisation algorithm determines the parameters of the polynomial that enable the predicted behaviour of the system to be obtained as close as possible to the reference trajectory. As such, the optimisation algorithm contains three steps. The first step consists in determining the coefficients of the polynomial. These coefficients are the search parameters for the optimisation algorithm and change with each iteration. The second step consists in evaluating the commands based on the polynomial. The number of commands can correspond to the number of sampling periods between the prediction horizon. The third step in the optimisation algorithm is to apply these commands to the prediction model. The fourth step consists in evaluating the cost function, i.e. comparing the predicted trajectory with the reference trajectory and taking the constraints into account in the form of barrier functions.

Determining 30 the m coefficients of the polynomial takes as an input the trajectory instruction, the prediction model and the at least one measurement of the mechatronic system for the current sampling period. It is thus possible to evaluate the difference between the prediction of the system state and the trajectory instruction.

Determining 30 of the m coefficients of the polynomial makes it possible to obtain a polynomial, the evaluation of which makes it possible to obtain the sequence ofn commands to be applied to the mechatronic system so that the system reaches the trajectory instruction for the prediction horizon. The sequence of commands comprises as many commands as the prediction horizon comprises sampling periods. For example, if the prediction horizon consists of n sampling periods, then the sequence of commands consists of n commands. The evaluation of the polynomial can therefore be used to obtain the value of the n commands for the n sampling periods.

The method 100 comprises calculating 40 a sequence of commands by evaluating the polynomial. Thus, by evaluating the polynomial for the prediction horizon, the value of the command to be applied at the present time is determined.

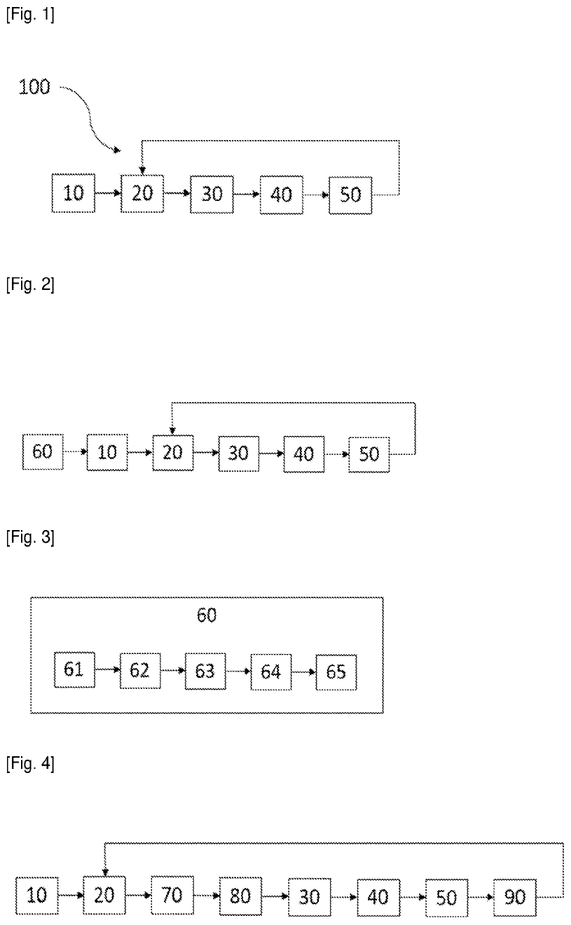

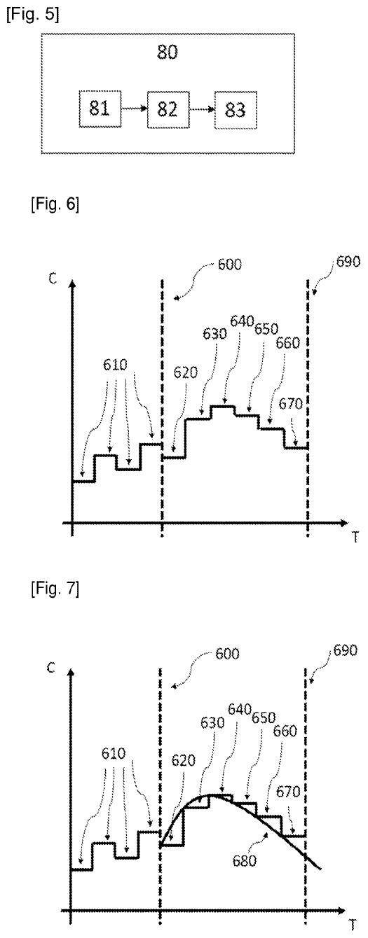

FIG. 7 is a graph showing an example of values of commands C as a function of time T. The present time is represented by the hatched line 600. The prediction horizon is the time between the hatched line 600 and the hatched line 690. The commands 610 have already been applied to the system. The evaluation of the polynomial 680 is used to determine the commands 620, 630, 640, 650, 660 and 670 predicted at the present time so that the mechatronic system follows the trajectory instruction over the entire prediction horizon.

The method 100 comprises applying 50 the command to the mechatronic system. The command 50 applied is the command to be applied at the present time. In other words, the command applied is the first command in the sequence of commands to be applied to cause the mechatronic system to follow the trajectory instruction for the prediction horizon 690. In addition, the command is optimised to minimise the energy required when following the trajectory instruction. With reference to FIG. 7, the command applied at step 50 is command 620.

Within the scope of a gyro-stabilised sight, the method 100 for controlling a gyro-stabilised sight is based on a prediction model of the behaviour of the gyro-stabilised sight and a cost function ensuring compliance with constraints by the gyro-stabilised sight for following a trajectory instruction for a prediction horizon. The method comprises:
reformulating 10 the constraints into barrier functions and integrating the barrier functions into the cost function;
for each sampling period of a sequence of sampling periods:
   obtaining 20 the trajectory instruction and at least one measurement of the gyro-stabilised sight in a current state;
   determining 30 coefficients of a polynomial of order m by a Nelder-Mead method optimising the cost function on the basis of the prediction model, the determination taking as an input the trajectory instruction and the at least one gyro-stabilised sight measurement obtained 20;
   calculating 40 a command by evaluating the polynomial; and
   applying 50 the command to the gyro-stabilised sight.

The aim of the invention is therefore to determine the coefficients of a polynomial, the evaluation of which makes it possible to obtain the sequence of commands to be applied so that the mechatronic system follows the trajectory instruction during the prediction horizon. Thus, it is possible to obtain a mechatronic system control method whose calculation time depends on the number of polynomial coefficients to be determined, which influences the calculation time required for the method. The user can therefore, as a function of the calculation time they desire to allocate to the control method, determine the order m of the appropriate polynomial. This determination of the order m of the polynomial could also be carried out semi-automatically or even automatically. In addition, the invention makes it possible to obtain a sequence of commands to be applied that minimises the energy required when following the trajectory instruction.

FIG. 2 shows a schematic representation of a first alternative. In this alternative, the control method 100 further comprises a prior step 60 of initialising the prediction model. Initialising 60 comprises determining the values of a set of parameters of the prediction model using an identification or learning algorithm taking as an input a sequence of step commands of random amplitude and duration and a set of measurements of the mechatronic system. Each measurement in the set of measurements of the mechatronic system is taken after each command in the sequence of commands has been applied to the mechatronic system. The correspondence between each measurement made and each command applied is known. This means that for each command there is a corresponding measurement, which can be gathered in pairs, for example. These “command-measurement” pairs can be provided to the identification or learning algorithm for value determination. In the present application, it is considered that the terms “learning” and “identification” designate any method aimed at obtaining a prediction model that “behaves like” the mechatronic system.

Initialising 60 can be carried out in different steps. FIG. 3 shows a schematic representation of the different steps of initialising 60. Initialising 60 the prediction model is carried out at least partly during an phase of initialising the mechatronic system, different from the phase of use of the mechatronic system. The first two steps 61 and 62 can be performed before the mechatronic system is started up, i.e. before the initialisation phase. The next three steps 63, 64 and 65 are performed during the initialisation phase, which requires the mechatronic system to be started.

Step 61 comprises defining by a user the high-level requirements based on the product specification and the order m of the polynomial. Defining the high-level requirements and/or the order m of the polynomial could also be performed semi-automatically or even automatically.

Step 62 comprises, for example, defining the type of prediction model to be used. Different types of prediction model can be used, such as neural networks or linear models. For example, if the model selected is a neural network, the type of neural network used and the number of neurons are determined in this step 62. If a linear model is selected, the order of the linear model is determined in this step 62. The choice of the type of prediction model to be used can be algorithmically determined or user-defined.

Step 63 comprises defining a sequence of step commands of random amplitude and random duration. It should be noted that the maximum amplitude and maximum duration of each command in the sequence of commands must be consistent with the maximum amplitude allowed by the system and its response time. In other words, the maximum amplitude of each command in the series of commands must be less than a ratio of the maximum amplitude admissible by the system, the ratio being within ]0; 1]. The maximum duration of each command in the sequence of commands must be greater than or equal to 5 times the system time constant. If a linear model has been selected in step 62, the series of step commands of random amplitude and duration may consist of a pseudo-random binary signal. A pseudo-random binary signal can be defined as being a signal made up of a series of elements, each of the elements having a binary value with a pseudo-random character: the binary value of each of its elements is independent of the others, but it is a periodic series, which makes it deterministic.

In step 64, the sequence of commands determined in step 63 is applied to the mechatronic system and at least one measurement of the state of the system is performed after applying each command of this sequence of commands. In one example, the at least one measurement of the state of the system corresponds to the same at least one measurement that will be performed during step 20. For example, if the at least one measurement during step 20 consists in measuring the absolute velocity of the sight measured by a gyrometer, a measurement of the absolute velocity of the sight measured by a gyrometer will be performed after applying each command of this sequence of commands during this step 64.

During step 65, the sequence of commands determined in step 63 and the sequence of the at least one corresponding measurement are used as an input data to determine the parameters of the prediction model.

In one example, the model is initialised using a recurrent neural network to represent dynamic systems. It is trained using a Levenberg-Marquardt gradient-based optimisation algorithm. It is also possible to use a recurrent neural network with a linear activation function. In this case, model initialisation consists in identifying a linear model using a recursive least squares algorithm.

In a second alternative, compatible with the preceding alternative, the m+1 vertices of the polytope on which the Nelder-Mead method is based are restricted within a predetermined range of values [xmin, xmax] for any change of the polytope during optimisation with for example xmin=−10⁶ and xmax=10⁶. The Nelder-Mead method as described in Nelder and Mead (1965) is unrestricted. In this second alternative, the decision variables are restricted to remain within a well-defined search space in order to promote convergence. The Nelder-Mead method is then said to be restricted. Thus, for any change in the polytope described in Nelder and Mead (1965), the vertices of the same are restricted to remain in the interval[xmin, xmax]. Said another way, if xⱼ is one of the vertices then: xⱼ=min (max(xⱼ,xₘᵢₙ),xₘₐₓ) for j=1, . . . s+1 for any change in the polytope.

With this second alternative, the convergence time of the restricted Nelder-Mead method is reduced. As a result, the calculating time of the control method using the restricted Nelder-Mead method can be further reduced.

In another alternative implementation, compatible with the preceding alternatives, the order m of the polynomial is between 2 and 5 and preferably equal to 3. The orderm of the polynomial influences the calculating time required by the control method for each sampling period. Hence, the greater the order m of the polynomial, the longer the calculation time.

The prediction horizon for a mechatronic system is, for example, at least equal to 20 sampling periods. Thus, for a conventional control method in which the sequence of commands to be determined comprises 20 commands, the optimisation algorithm searches for the set of future commands to be applied to the system, i.e. 20 parameters. In the present invention, for a prediction horizon of the same duration, with a polynomial of order 3, only 3 parameters are searched using the Nelder-Mead method or the restricted Nelder-Mead method. This reduces the calculation time required to determine the parameters relative to the conventional control method.

An implementation on an Intel® Core™ i7 processor of the control method for a gyro-stabilised sight using a restricted Nelder-Mead method with an order m of polynomial equal to 3 is compatible with a sampling frequency at least equal to 400 Hertz.

In one alternative, compatible with the preceding alternatives, obtaining 20 of the control method 100 further comprises estimating in real time a current state of the mechatronic system from the at least one measurement of the mechatronic system for the current sampling period performed by an observer included in the mechatronic system. For example, the observer will make it possible to interpret the at least one measurement of the mechatronic system which is not necessarily directly interpretable by the corrector. Thus, the observer will make it possible to determine the state initiating the prediction of the system in the optimisation process.

An alternative implementation of the method 100, compatible with the preceding alternatives, comprises several additional steps, for at least one sampling period of the sequence of sampling periods different from the first period of the sequence. In a first example implementation, all sampling periods, except the first sampling period, of the sequence of sampling periods contain steps 20, 30, 40, 50, 70, 80 and 90 or contain at least steps 20, 30, 40 and 50, 81 and 90. In a second example, an alternation between one or more sampling periods containing steps 20, 30, 40 and 50 and one or more sampling periods containing steps 20, 30, 40, 50, 70, 80 and 90 can be predetermined automatically. Alternation can also be triggered automatically or by user-computer interaction. Another implementation example could be to alternate between one or more sampling periods containing steps 20, 30, 40 and 50, 81 and 90 and one or more sampling periods containing steps 20, 30, 40, 50, 70, 80 and 90. FIG. 4 shows a schematic representation of this alternative implementation.

In this alternative, a first replacement step 70 is added before determining 30 the coefficients of the polynomial. This replacement step 70 consists in replacing the barrier functions of step 10 with new barrier functions, the new barrier functions being a reformulation of new constraints. These new constraints replace the constraints initially provided. In other words, in this implementation alternative, constraints different from those initially defined are integrated into the cost function during the phase of use of the mechatronic system. Integration into the cost function at step 70 can be carried out in the same way as in reformulation 10.

In this alternative, a second step 80 is added after obtaining 20 the trajectory instruction and the at least one measurement of the mechatronic system and before determining 30 the coefficients of the polynomial. Step 80 may comprise 3 steps 81, 82 and 83. This step 80 may be performed before or after step 70. FIG. 5 shows a schematic representation of the different steps in step 80.

Step 81 consists in saving the at least one measurement of the mechatronic system for the current sampling period in a first variable.

Step 82 consists in determining a value for the parameters of the prediction model. In other words, in step 82, each parameter of the prediction model is defined by assigning it a value. This determination requires as an input at least some of the at least one measurements of the mechatronic system obtained during preceding sampling periods saved in the first variable and at least some of the first commands applied to the mechatronic system during preceding sampling periods saved in a second variable. The at least one measurement of the mechatronic system obtained in previous sampling periods is saved in step 90. In order to use these data as an input, the correspondence between each measurement of the mechatronic system and an applied command should be known. In other words, a “command-measurement” pair with the measurement corresponding to the at least one measurement of the mechatronic system made after the command of the pair has been applied to the mechatronic system may for example be constructed and used by the identification algorithm. Determination 82 may be performed in a similar manner as initialisation 60, especially the same identification algorithm may be used.

In a first example implementation of step 82, all the measurements saved in step 81 and all the commands saved in step 90 are used as input data. In a second example implementation of step 82, only the measurements saved in step 81 for the last sampling periods and the commands saved in step 90 for the last sampling periods are used as input data. For example, only the measurements saved in step 81 and the commands saved in step 90 for the last 10,000 sampling periods are used for determination 82.

Step 83 consists in replacing a current value of the prediction model parameters with the value determined for the prediction model parameters in step 82. In other words, a new value, which has been determined in step 82, for each parameter of the prediction model is assigned to the different parameters of the prediction model. Thus, the current values of the different parameters in the prediction model are replaced.

A third step 90 is added after calculating 40 the sequence of commands. Step 90 consists in saving the first command of the sequence of commands calculated for the current sampling period in a second variable.

This implementation alternative comprising steps 70, 80 and 90 makes it possible to obtain a self-adaptive control method. Thus, this implementation alternative has the ability to adapt both to variations in the environment and variations in the constraints linked to variations in high-level requirements and/or specifications during the phase of use of the mechatronic system. Indeed, the calculation time remains sufficiently low even when a sampling period comprises steps 20, 30, 40, 50, 70, 80 and 90. An implementation of this alternative on an Intel® Core™ i7 processor of the control method for a gyro-stabilised sight using a restricted Nelder-Mead method with an order m of polynomial equal to 3 has a sampling frequency at least equal to 400 Hertz.

1. A method for controlling a mechatronic system, based on a prediction model of the behaviour of the mechatronic system and a cost function ensuring compliance with constraints by the mechatronic system, for the mechatronic system to follow a trajectory instruction during a prediction horizon, the method:
reformulating the constraints into barrier functions and integrating the barrier functions into the cost function; and
for each sampling period of a sequence of sampling periods:
obtaining the trajectory instruction and at least one measurement of the mechatronic system in a current state;
determining coefficients of a polynomial of order m by a Nelder-Mead method optimising the cost function on the basis of the prediction model, the determination taking as an input the trajectory instruction and the at least one measurement of the mechatronic system obtained
calculating a sequence of commands by evaluating the polynomial; and
applying the first command of the sequence of commands to the mechatronic system.

2. The control method according to claim 1, further comprising a prior step of initialising the prediction model comprising determining the values of a set of parameters of the prediction model using an identification algorithm taking as an input a sequence of step commands of random amplitude and duration and a set of measurements of the mechatronic system, each measurement of the set of measurements of the mechatronic system being carried out after applying each command of the sequence of commands to the mechatronic system.

3. The method according to claim 1 claims, wherein the Nelder-Mead method optimising the cost function is based on a polytope with m+1 vertices, with m the order of the polynomial, whose m+1 vertices are restricted within a predetermined interval of values [xmin, xmax] for any change of the polytope during optimisation.

4. The method according to claim 1, wherein the order m of the polynomial is between 2 and 20.

5. The control method according to claim 1, wherein obtaining the trajectory instruction and at least one measurement of the mechatronic system in a current state further comprises estimating in real-time a current state of the mechatronic system from the at least one measurement of the mechatronic system obtained, estimating being performed by an observer included in the mechatronic system.

6. The control method according to claim 1, wherein at least one sampling period of the sequence of sampling periods different from a first sampling period of the sequence of sampling periods further comprises:
before determining the coefficients of the polynomial, replacing the barrier functions with new barrier functions, the new barrier functions being a reformulation of new constraints;
after obtaining the trajectory instruction and the at least one measurement of the mechatronic system and before determining the coefficients of the polynomial, a step comprising:
saving the at least one measurement of the mechatronic system obtained in a first variable;
determining a value of the parameters of the prediction model on the basis of an identification algorithm taking as an input:
at least one part of the at least one measurement of the mechatronic system obtained during preceding sampling periods saved in the first variable; and
at least one part of the first commands of the sequence of commands calculated to the mechatronic system during preceding sampling periods saved in a second variable;
replacing a current value of the parameters of the prediction model with the value determined; and
after calculating the command:
saving the first command of the sequence of commands calculated in a second variable.

7. A mechatronic system comprising:
a processor implementing the control method according to claim 1; and
a system adapted to obtain at least one measurement of the mechatronic system.

8. A gyro-stabilised sight comprising:
a processor implementing the control method according to claim 1; and
a system adapted to obtain at least one measurement of the gyro-stabilised sight.

9. A non-transitory computer program product comprising instructions which, when the program is executed by a computer, cause the same to carry out the method according to claim 1.

10. A non-transitory computer-readable recording medium comprising instructions which, when executed by a computer, cause the same to carry out the method according to claim 1.

11. The method according to claim 4, wherein the order m of the polynomial is 3.
